(19) United States
(12) Patent Application Publication
(10) Pub. No.: US 2006/0195265 A1
(43) Pub. Date: Aug. 31, 2006

(54) METHOD OF MEASURING STICK SLIP, AND SYSTEM FOR PERFORMING SAME

(75) Inventors: Aaron Schen, Houston, TX (US); Marcel Luke Boucher, Houston, TX (US); Brett Stanes, Houston, TX (US); Adrian Snell, Houston, TX (US)

Correspondence Address: JEFFREY E. DALY;GRANT PRIDECO, L.P., 400 N. SAM HOUSTON PARKWAY EAST, SUITE 900, HOUSTON, TX, 77060, US

(73) Assignee: REEDHYCALOG LP, Houston, TX (US)

(21) Appl. No.: 11/307,635

(22) Filed: Feb. 15, 2006

Related U.S. Application Data
(60) Provisional application No. 60/653,889, filed on Feb. 17, 2005.

(51) Int. Cl. G01V 1/40

(52) U.S. Cl. 702/9

(57) ABSTRACT

Disclosed is a method of measuring stick slip in an earth drilling system, and a system for performing same. The method includes positioning an accelerometer in a downhole component of a drill string, the accelerometer being radially offset from a centerline of the downhole component, obtaining acceleration data for the drill string during drilling operations using the accelerometer and determining if the drill string has experienced stick slip based upon mean acceleration values obtained by analyzing the acceleration data obtained using the accelerometer.

### CROSS-REFERENCE TO RELATED APPLICATIONS

The present application claims priority to U.S. Provisional Patent Application Ser. No. 60/653,889 filed Feb. 17, 2005, the entire contents of which is specifically incorporated herein by reference in its entirety.

### BACKGROUND OF THE INVENTION

1. Field of the Invention

The present invention is generally related to the field of drilling oil and gas wells, and, more specifically, to a method of measuring stick slip, and a system for performing same.

2. Description of the Related Art

Oil and gas wells are formed by a rotary drilling process. To that end, a drill bit is mounted on the end of a drill string which may be very long, e.g., several thousand feet. At the surface, a rotary drive mechanism turns the drill string and the attached drill bit at the bottom of the hole. In some cases, a downhole motor may provide the desired rotation to the drill bit. During drilling operations, a drilling fluid (so-called drilling mud) is pumped through the drill string and back up-hole by pumps located on the surface. The purpose of the drilling fluid is to, among other things, remove the earthen cuttings resulting from the drilling process.

When the drill bit wears out or breaks during drilling, it must be brought up out of the hole. This requires a process called “tripping,” wherein a heavy hoist pulls the entire drill string out of the hole in stages of, for example, about ninety feet at a time. After each stage of lifting, one “stand” of pipe is unscrewed and laid aside for re assembly (while the weight of the drill string is temporarily supported by another mechanism). Since the total weight of the drill string may be several tons, and the length of the drill string may be tens of thousands of feet, this is not a trivial job. One trip can require many man-hours and, thus, tripping is a significant expense of the drilling budget. To resume drilling, the entire process must be reversed. Thus, the bit's durability is very important to minimize the number of times a bit is replaced during drilling.

Stick slip occurs when a bit gets stuck in the formation it is drilling. Because the drill string is relatively long compared to its stiffness, the drill string can wind up and build torque in the string until the bit breaks free. FIG. 1 is a set of graphs depicting the impact of stick slip on drilling operations. As can be seen from the data in FIG. 1, in the time period t1, when the drill bit is stuck (RPM is approximately zero), the torque on the bit gradually increases. During the time period t2, the bit breaks loose leading to a sudden, rapid increase in the rotation of the drill bit and a sudden decrease in torque. This pattern substantially repeats itself at time periods t3 (drill bit stuck) and t4 (drill bit breaks loose). This process can occur in cycles for long periods of time.

Stick slip is undesirable because it may be very damaging to drill string components and can reduce ROP (rate of penetration). Connections can get over-torqued and twist off. The bit can get severely damaged from the excessive RPM and vibration that result from stick slip. It is often not apparent at the surface when stick slip is occurring downhole. The drill string at the surface can appear to be drilling smoothly even though the RPM at the bit is erratic. All of the aforementioned problems can lead to inefficient drilling and, in some cases, excessive and costly tripping of the bit out of the hole.

While some traditional MWD (measurement-while-drilling) equipment can be employed to identify various dynamic problems, such equipment is typically located in the drill string well above the drill bit. The dynamic activity that occurs at the location of such MWD equipment and the dynamic activity that occurs at the drill bit can be drastically different. It is currently possible to measure downhole stick slip using magnetometer sensors. Such magnetometers must be located away from magnetic noise and shielding, which can be caused by the ferrous materials used for casing and other bottom hole assembly (BHA) equipment. Typically, expensive non-magnetic materials must be used to construct the equipment that will hold such magnetometer sensors. The tools employing such magnetometer sensors also typically require relatively sophisticated algorithms to precisely detect stick slip.

The present invention is directed to devices and methods that may solve, or at least reduce, some or all of the aforementioned problems.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is generally directed to a method of measuring stick slip, and a system for performing same. In one illustrative embodiment, the method comprises positioning an accelerometer in a downhole component of a drill string, the accelerometer being radially offset from a centerline of the downhole component, obtaining acceleration data for the drill string during drilling operations using the accelerometer and determining if the drill string has experienced stick slip based upon mean acceleration values obtained by analyzing the acceleration data obtained using the accelerometer.

In another illustrative embodiment, the method comprises positioning a single accelerometer in a downhole component of a drill string, the single accelerometer being radially offset from a centerline of the downhole component, obtaining acceleration data for the drill string during drilling operations using the single accelerometer and determining if the drill string has experienced stick slip based upon the acceleration data obtained using the single accelerometer.

In yet another illustrative embodiment, the method comprises positioning at least one accelerometer in a downhole component of a drill string, the at least one accelerometer being radially offset from a centerline of the downhole component, obtaining acceleration data for the drill string during drilling operations using the at least one accelerometer and performing at least one mean processing step on the acceleration data obtained using the at least one accelerometer to detect stick slip of the drill string.

In a further illustrative embodiment, the method comprises positioning a single accelerometer in a downhole component of a drill string, the single accelerometer being radially offset from a centerline of the downhole component, obtaining acceleration data for the drill string during drilling operations using the single accelerometer and performing at least one mean processing step on the acceleration data obtained using the single accelerometer to detect stick slip of the drill string.

### BRIEF DESCRIPTION OF THE DRAWINGS

The invention may be understood by reference to the following description taken in conjunction with the accompanying drawings, in which like reference numerals identify like elements, and in which:

FIG. 1 is a graph depicting illustrative examples of stick slip for a drill string.

FIG. 2 is a schematic depiction of one illustrative embodiment of a system that may be employed in accordance with one aspect of the present invention.

FIG. 3 is another illustrative graph depicting slip stick occurring on a drill string.

FIG. 4 is an illustrative drill string having an accelerometer positioned therein.

FIGS. 5 and 6 are various views of an illustrative removable plug that may be employed to house the accelerometer described herein.

FIG. 7 is an illustrative graph depicting basic RPM data, raw acceleration data and mean acceleration data to explain basic aspects of the methods disclosed herein.

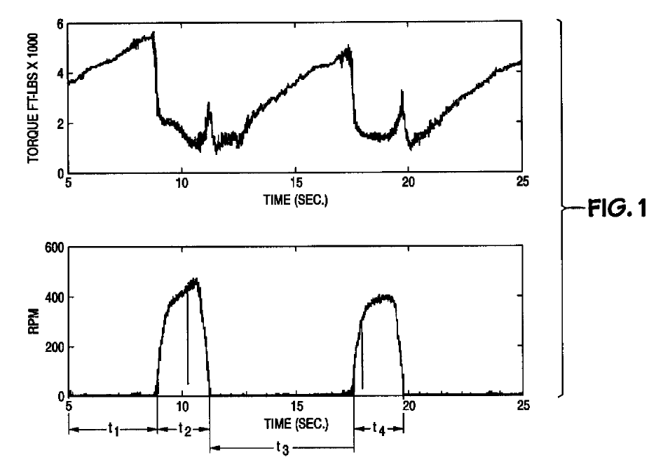

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached drawings and charts which are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

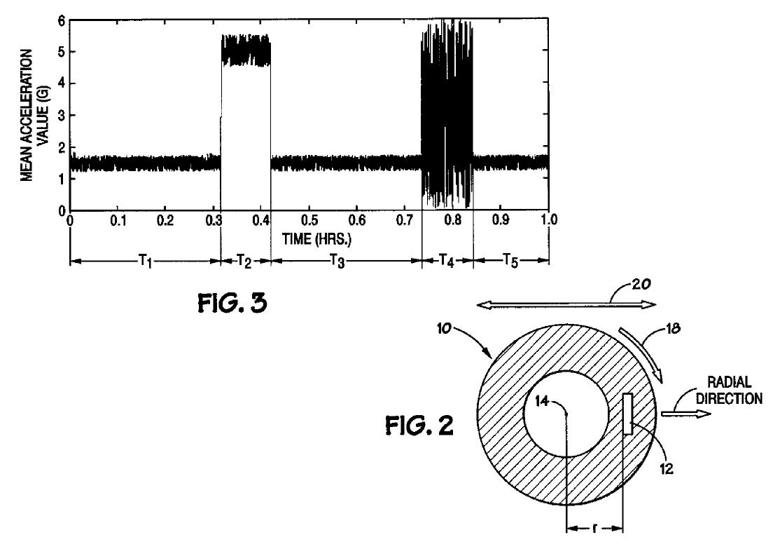

FIG. 2 is a schematic depiction of an illustrative downhole device 10 having an accelerometer 12 mounted therein. The accelerometer 12 is positioned at a radial distance “r” from the center 14 of the device 10. In one illustrative embodiment, the device 10 may be a drill collar positioned immediately above a drill bit (not shown). In other applications, the device 10 may be an actual drill bit. The accelerometer 12 may be mounted at any location in the drill string. For example, it may be mounted in a downhole device positioned above or below a downhole motor. In general, all other things being equal, the closer the accelerometer 12 can be placed to the drill bit, the better, as the data obtained using the accelerometer 12 will be more reflective of the conditions at or near the drill bit.

The invention is basically for a downhole measurement technique to detect stick slip. In one illustrative embodiment, the present invention may only involve use of a single accelerometer 12 and the processing to be described more fully below. The invention relies on the fact that, if the accelerometer 12 is placed off the centerline 14 of the device 10, e.g., a drill collar, it will “see” or sense the centripetal acceleration from the rotation 18 of the device 10. The radius “r” may vary depending on the particular application. The larger the radius, the better the acceleration measurement. In general, in most applications, the minimum value of the radius should be approximately 1.5-2 inches. Centripetal acceleration can be used to detect stick slip because it will vary with the RPM as the bit “sticks and slips.” The accelerometer 12 will also “see” or sense random accelerations from the normal drilling process (so-called “lateral acceleration”). The lateral acceleration occurs in the direction indicated by the arrow 20 in FIG. 2.

In accordance with one aspect of the present invention, a plurality of mean acceleration values are determined by analyzing the acceleration data obtained using the accelerometer 12. In other embodiments, this analysis may take the form of a low-pass filter that is applied to the acceleration data obtained using the accelerometer 12.

In one example, a mean processing step effectively separates the centripetal acceleration from the other drilling accelerations (lateral). The mean acceleration values (centripetal acceleration) can then be used to determine if stick slip is present.

In the position indicated in FIG. 2, the accelerometer 12 measures both lateral acceleration, which is natural to the drilling process, and the centripetal acceleration, which is caused by rotation. The formula for centripetal acceleration is:
Aₐ=Ac+A₁ Aₐ=accelerometer measurement

A_{c}=centripetal acceleration

A₁=lateral acceleration

In one illustrative embodiment, the data is continuously sampled from the accelerometer 12 at a high rate. The data is then streamed into blocks, which, in one illustrative embodiment, may be between 0.5 seconds to 5 seconds long. In one particular embodiment, the blocks may be approximately 2.5 seconds long. The mean acceleration is calculated for each block of data. The mean of the lateral acceleration component must be very near zero for the device to remain within the bore. Therefore, the calculated mean acceleration value is comprised substantially entirely of the centripetal component. While the centripetal component is small compared with the overall peak levels of acceleration, the mean acceleration value is still determined accurately because of the large sample size of each buffer period. During normal drilling operations, the mean acceleration values will be near constant over time. The mean acceleration values will have a large dynamic range in the case where the stick slip period is longer than the buffer period. If the stick slip period is shorter than the buffer period, the mean acceleration values will appear elevated. Examples of data are shown in FIG. 3. The nature of the centripetal acceleration is that it is a constant or “DC” value and it will remain at an approximately constant, non-zero value if the bit is rotating smoothly.

In one illustrative embodiment, the mean processing step is accomplished by taking a few seconds worth of data from the accelerometer 12 at a time and calculating the mean or average value of the acceleration. This is done repeatedly every few seconds. The resulting mean acceleration values can be compared. If the mean acceleration values are constant over time, stick slip is not occurring and the bit is rotating smoothly. If the mean acceleration values are not approximately constant, then stick slip is present. In FIG. 3, the y-axis represents the mean acceleration value (g), while the x-axis is drilling time (hrs). During the periods T1, T3 and T5, normal drilling operations are occurring as the mean acceleration values are approximately constant during these periods. The time period T2 is a period where stick slip is occurring as indicated by the sudden increase in the mean acceleration values. More specifically, during the time period T2, the data indicates that the bit is experiencing “short period” stick slip, i.e., the stick slip period is shorter than the buffer period. At time period T4, the data further indicates that stick slip is occurring given the change in the mean acceleration values. However, in the period T4, the stick slip is a long period stick slip, i.e., the stick slip period is longer than the buffer period.

As described above, the mean acceleration values may be examined to determine if stick slip is present. In some cases, e.g., time period T2 in FIG. 3, the mean acceleration values have a substantially higher value than the mean acceleration values in the period T1. However, in the period T2, the range of the mean acceleration values is relatively constant, i.e., a relatively low variance. In contrast, the mean acceleration values in the period T4 exhibit a relatively wide variance or standard deviation. Determining whether stick slip is present may be determined based upon peak-to-peak variations (e.g., a comparison of high mean acceleration values to low mean acceleration values) or variances or standard deviations of the mean acceleration values under examination.

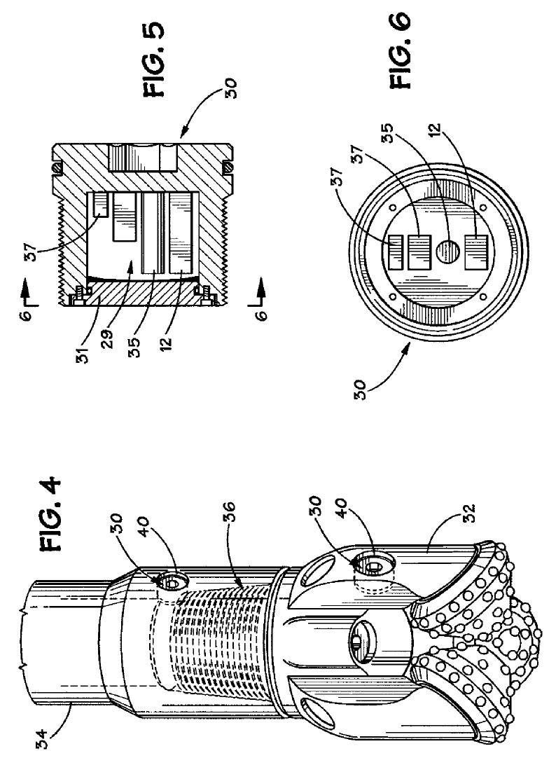

The accelerometer 12 disclosed herein may be mounted directly into a downhole device such as, for example, a downhole sub, a drill bit, a drill collar, etc. Alternatively, the accelerometer 12 disclosed herein may be mounted in a small housing 30 depicted in FIGS. 4-6. More details regarding the structure, use and operation of the housing 30 is disclosed in pending U.S. patent application Ser. No. 10/711,608, entitled “Removable Sealed Equipment Housing for Downhole Measurements,” which is hereby incorporated by reference in its entirety. As depicted in FIGS. 4-6, the housing 30 comprises a cavity 29 and a lid 31. The housing 30 may be positioned in the illustrative roller cutter drill bit 32 or in the illustrative downhole device 34 that is threadingly coupled to the drill bit 32 via the threaded connection 36. More specifically, in one illustrative embodiment, the housing 30 may be threadingly coupled to the openings 40 shown in FIG. 4. The accelerometer 12 and other associated equipment may be positioned in the cavity 29 of the housing 30. For example, an illustrative memory device 35 and battery 37 are shown in FIGS. 5 and 6 as supporting equipment for use of the accelerometer 12.

The accelerometer 12 may be any type of accelerometer sufficient to perform the functions described herein. In one illustrative embodiment, the accelerometer 12 may be an ADXL190 accelerometer manufactured by Analog Devices. Of course, more than one such accelerometer may be employed if desired.

Field operation of a tool containing the accelerometer 12 described herein is relatively simple. A single person can activate the tool in just a few minutes. In one illustrative embodiment, the accelerometer 12 is positioned in the housing 30 described above and then threaded into the opening 40 in the short collar 34 above the bit 32. In one illustrative embodiment, the tool operates in memory mode, which means the data can only be accessed after the tool is retrieved. Raw data is sampled at a high rate and the computed values are stored every few seconds. Acquired data is downloaded to a laptop computer when the bit 32 has been tripped out of the hole. Logs of maximum lateral acceleration, root mean squared (RMS) lateral acceleration and the mean acceleration (which equates to the centripetal acceleration) can then be produced. This type of data is useful for optimizing parameters between multiple bit runs in similar offsets. The accelerometer 12 described herein may also provide real-time data using known telemetry equipment and techniques. However, in many applications for this tool, the expensive telemetry equipment required to collect real-time data will not be readily available. In such situations, the tool may be operated in memory mode and provide important data to enable more efficient and productive drilling of oil and gas wells.

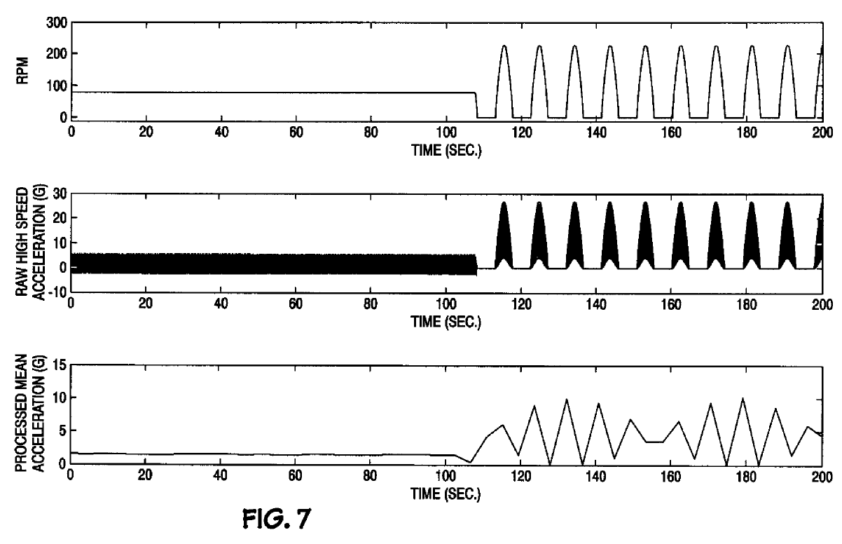

FIG. 7 is a collection of three graphs. The horizontal axis for all three graphs is time in seconds. The upper graph depicts the RPMs of the drill string. The middle graph is raw acceleration data (g) sensed by the accelerometer 12. The bottom graph is the mean acceleration values derived or filtered from the acceleration data obtain by the accelerometer 12 (shown in the middle graph). As can be seen in all of the graphs, for the period from approximately 0-110 seconds, the drill string is rotating smoothly and no stick slip is occurring. Thereafter, each of the graphs indicate that the drill string is experiencing stick slip, as indicated by the rapid change in values, over time, of the RPMs, raw acceleration data, and processed mean acceleration data. Drill string RPM values are very difficult to precisely sense, especially at remote downhole locations. The raw acceleration data also indicates stick slip, but the massive volume of such data makes it difficult and cumbersome to work with. In accordance with the present invention, the mean acceleration values also reflect stick slip, as described above, but involve less data due to the processing/filtering techniques described previously.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method, comprising:
positioning an accelerometer in a downhole component of a drill string, said accelerometer being radially offset from a centerline of said downhole component;
obtaining acceleration data for said drill string during drilling operations using said accelerometer; and
determining if said drill string has experienced stick slip based upon mean acceleration values obtained by analyzing said acceleration data obtained using said accelerometer.

2. The method of claim 1, wherein positioning said accelerometer in a downhole component comprises positioning said accelerometer in a housing that is positioned in said downhole component.

3. The method of claim 2, wherein said housing is threadingly positioned in an opening formed in said downhole component.

4. The method of claim 2, wherein said housing is removably positioned in an opening in said downhole component.

5. The method of claim 1, wherein said downhole component is a drill bit.

6. The method of claim 1, wherein said downhole component is a drill collar.

7. The method of claim 1, wherein said downhole component is a component positioned above a drill bit.

8. The method of claim 1, wherein determining if said drill string has experienced stick slip based upon mean acceleration values obtained by analyzing said acceleration data obtained using said accelerometer comprises:
calculating mean acceleration values based upon said obtained data over a time period; and
identifying slip stick by examining said calculated mean acceleration values for changes during said time period.

9. The method of claim 1, wherein determining if said drill string has experienced stick slip based upon mean acceleration values obtained by analyzing said acceleration data obtained using said accelerometer comprises:
calculating mean acceleration values based upon said obtained data over a time period; and
identifying slip stick by examining a difference between high and low mean acceleration values during said time period.

10. The method of claim 1, wherein determining if said drill string has experienced stick slip based upon mean acceleration values obtained by analyzing said acceleration data obtained using said accelerometer comprises:
calculating mean acceleration values based upon said obtained data over a time period; and
identifying slip stick by examining a variance in mean acceleration values during said time period.

11. The method of claim 1, wherein analyzing said acceleration data comprises analyzing said acceleration data obtained using said accelerometer by using a low-pass filter.

12. The method of claim 1, wherein analyzing said acceleration data comprises analyzing said acceleration data obtained using accelerometer by calculating said mean acceleration values.

13. A method, comprising:
positioning a single accelerometer in a downhole component of a drill string, said single accelerometer being radially offset from a centerline of said downhole component;
obtaining acceleration data for said drill string during drilling operations using said single accelerometer; and
determining if said drill string has experienced stick slip based upon mean acceleration values obtained by analyzing said acceleration data obtained using said single accelerometer.

14. The method of claim 13, wherein positioning said single accelerometer in a downhole component comprises positioning said single accelerometer in a housing that is positioned in said downhole component.

15. The method of claim 13, wherein determining if said drill string has experienced stick slip based upon mean acceleration values obtained by analyzing said acceleration data obtained using said at least one accelerometer comprises:
calculating mean acceleration values based upon said obtained data over a time period; and
identifying slip stick by examining said calculated mean acceleration values for changes during said time period.

16. The method of claim 13, wherein determining if said drill string has experienced stick slip based upon mean acceleration values obtained by analyzing said acceleration data obtained using said at least one accelerometer comprises:
calculating mean acceleration values based upon said obtained data over a time period; and
identifying slip stick by examining a difference between high and low mean acceleration values during said time period.

17. The method of claim 13, wherein determining if said drill string has experienced stick slip based upon mean acceleration values obtained by analyzing said acceleration data obtained using said at least one accelerometer comprises:
calculating mean acceleration values based upon said obtained data over a time period; and
identifying slip stick by examining a variance in mean acceleration values during said time period.

18. The method of claim 13, wherein analyzing said acceleration data obtained using said at least one accelerometer comprises analyzing said acceleration data obtained using said at least one accelerometer by using a low-pass filter.

19. The method of claim 13, wherein analyzing said acceleration data obtained using said at least one accelerometer comprises analyzing said acceleration data obtained using said at least one accelerometer by calculating said mean acceleration values.

20. A method, comprising:
positioning at least one accelerometer in a downhole component of a drill string, said at least one accelerometer being radially offset from a centerline of said downhole component;
obtaining acceleration data for said drill string during drilling operations using said at least one accelerometer; and
performing at least one mean processing step on said acceleration data obtained using said at least one accelerometer to detect stick slip of said drill string.

21. The method of claim 20, wherein positioning said at least one accelerometer in a downhole component comprises positioning said at least one accelerometer in a housing that is positioned in said downhole component.

22. The method of claim 21, wherein said housing is threadingly positioned in an opening formed in said downhole component.

23. The method of claim 21, wherein said housing is removably positioned in an opening in said downhole component.

24. The method of claim 20, wherein said downhole component is a drill bit.

25. The method of claim 20, wherein said downhole component is a drill collar.

26. The method of claim 20, wherein said downhole component is a component positioned above a drill bit.

27. The method of claim 20, wherein processing said acceleration data comprises:
calculating mean acceleration values based upon said obtained data over a time period; and
identifying slip stick by examining said calculated mean acceleration values for changes during said time period.

28. The method of claim 20, wherein determining if said drill string has experienced stick slip based upon mean acceleration values obtained by analyzing said acceleration data obtained using said at least one accelerometer comprises:
calculating mean acceleration values based upon said obtained data over a time period; and
identifying slip stick by examining a difference between high and low mean acceleration values during said time period.

29. The method of claim 20, wherein determining if said drill string has experienced stick slip based upon mean acceleration values obtained by analyzing said acceleration data obtained using said at least one accelerometer comprises:
calculating mean acceleration values based upon said obtained data over a time period; and
identifying slip stick by examining a variance in mean acceleration values during said time period.

30. The method of claim 20, wherein analyzing said acceleration data obtained using said at least one accelerometer comprises analyzing said acceleration data obtained using said at least one accelerometer by using a low-pass filter.

31. The method of claim 20, wherein analyzing said acceleration data obtained using said at least one accelerometer comprises analyzing said acceleration data obtained using said at least one accelerometer by calculating said mean acceleration values.

32. A method, comprising:
positioning a single accelerometer in a downhole component of a drill string, said single accelerometer being radially offset from a centerline of said downhole component;
obtaining acceleration data for said drill string during drilling operations using said single accelerometer; and
performing at least one mean processing step on said acceleration data obtained using said single accelerometer to detect stick slip of said drill string.

33. The method of claim 32, wherein positioning said single accelerometer in a downhole component comprises positioning said single accelerometer in a housing that is positioned in said downhole component.

34. The method of claim 32, wherein processing said acceleration data comprises:
calculating mean acceleration values based upon said obtained data over a time period; and
identifying slip stick by examining said calculated mean acceleration values for changes during said time period.

35. The method of claim 32, wherein determining if said drill string has experienced stick slip based upon mean acceleration values obtained by analyzing said acceleration data obtained using said at least one accelerometer comprises:
calculating mean acceleration values based upon said obtained data over a time period; and
identifying slip stick by examining a difference between high and low mean acceleration values during said time period.

36. The method of claim 32, wherein determining if said drill string has experienced stick slip based upon mean acceleration values obtained by analyzing said acceleration data obtained using said at least one accelerometer comprises:
calculating mean acceleration values based upon said obtained data over a time period; and
identifying slip stick by examining a variance in mean acceleration values during said time period.

37. The method of claim 32, wherein analyzing said acceleration data obtained using said at least one accelerometer comprises analyzing said acceleration data obtained using said at least one accelerometer by using a low-pass filter.
